(19) United States
(12) Patent Application Publication
(10) Pub. No.: US 2012/0242493 A1
(43) Pub. Date: Sep. 27, 2012

(54) Movement responding device for mobile object

(75) Inventor: Lin Wei Tsai, Hsinchu (TW)

(73) Assignee: Fun Tram Corporation

(21) Appl. No.: 13/065,450

(22) Filed: Mar. 22, 2011

(51) Int. Cl. G08B 21/00

(52) U.S. Cl. 340/670

(57) ABSTRACT

A movement responding device includes a housing, a circuit board disposed in the housing, a control device mounted on the circuit board, a light device attached to the circuit board and electrically connected to the control device for generating a light, and a movement detector attached to the circuit board and electrically connected to the control device for detecting a movement of an object or a user and for supplying a detected information to the control device and for actuating the light device to generate the light when sensed or detected a movement of the object or the user or in automatic response to the detection of ambient movement or sound.

### BACKGROUND OF THE INVENTION

1. Field of the Invention

The present invention relates to a movement responding device for sensing or detecting a movement of an object or a user, and more particularly to a movement responding device including a signal generating device for generating a sound or light signal or for reproducing a comforting voice when sensed or detected a movement of an object or a user or in automatic response to the detection of ambient movement or sound.

2. Description of the Prior Art

Typically, the nurse cares should take a careful notice to the children or the infants who may move or may cry when they are wake up, and the nurse cares require a suitable sensing or detecting device to sense or detect the movement or the sound of the children or the infants in order to act in response to the movement or the sound of the children or the infants.

For example, U.S. Pat. No. 4,640,034 to Zisholtz discloses one of the typical mobile detectors comprising an actuating device for operating a player and mobile in automatic response to the detection of ambient sound, and including a voice actuated means for operating a cassette tape player means or the like to reproduce a comforting voice and causing the mobile to move in response to sensed sound.

However, the typical mobile detectors may not be used to respond to the detection of ambient movement such that the users may not know or detect the movement of the children or the infants or other users. In addition, the typical mobile detectors may not be attached or mounted or secured onto the user to detect the movement of the user.

The present invention has arisen to mitigate and/or obviate the afore-described disadvantages of the conventional movement responding devices.

### SUMMARY OF THE INVENTION

The primary objective of the present invention is to provide a movement responding device including a signal generating device for generating a sound or light signal or for reproducing a comforting voice when sensed or detected a movement of an object or a user or in automatic response to the detection of ambient movement or sound.

In accordance with one aspect of the invention, there is provided a movement responding device comprising a housing including a chamber formed therein, and a circuit board disposed in the chamber of the housing and including a control device mounted on the circuit board, and including a light device attached to the circuit board and electrically connected to the control device for generating a light, and including a movement detector attached to the circuit board and electrically connected to the control device for detecting a movement of an object and for supplying a detected information to the control device and for actuating the light device to generate the light signal or the like in automatic response to the detection of ambient movement.

The housing includes a cover pivotally attached to the housing with a pivot axle for covering the parts or elements of the movement responding device within the housing. The housing includes at least one attachment element for attaching the housing to a supporting object, such as a supporting table, a user, or other supporting members or elements.

The housing includes a coupling device for attaching the housing to a supporting object. The circuit board includes at least one memory attached to the circuit board and electrically connected to the control device for storing a sound or voice or music or the like.

The circuit board includes a sound detector attached to the circuit board and electrically connected to the control device for detecting an ambient sound and for supplying the sensed or detected data or information or signal or sound to the control device. A sound generating device may further be provided and electrically connected to the control device for generating or displaying the sound or voice or music supplied from the control device and the memory.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a movement responding device in accordance with the present invention;

FIG. 2 is a perspective view of the movement responding device;

FIG. 3 is a block diagram illustrating the parts or elements of the movement responding device;

FIG. 4 is a perspective view illustrating the operation of the movement responding device;

FIG. 5 is another partial exploded view illustrating the operation of the movement responding device; and

FIG. 6 is a perspective view illustrating the operation of the movement responding device.

### DETAILED DESCRIPTION OF THE PREFERRED EMBODIMENT

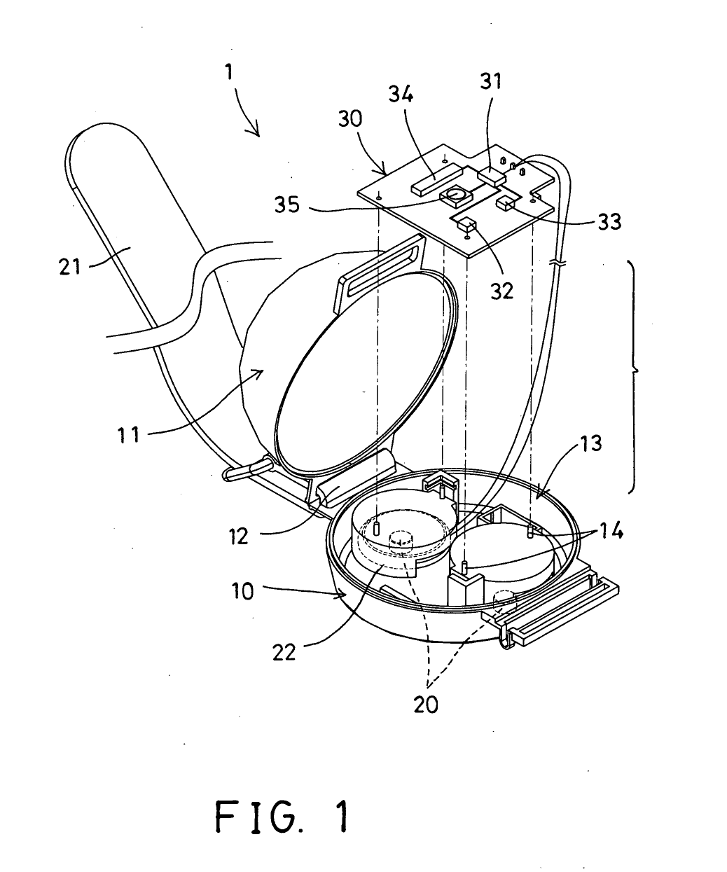

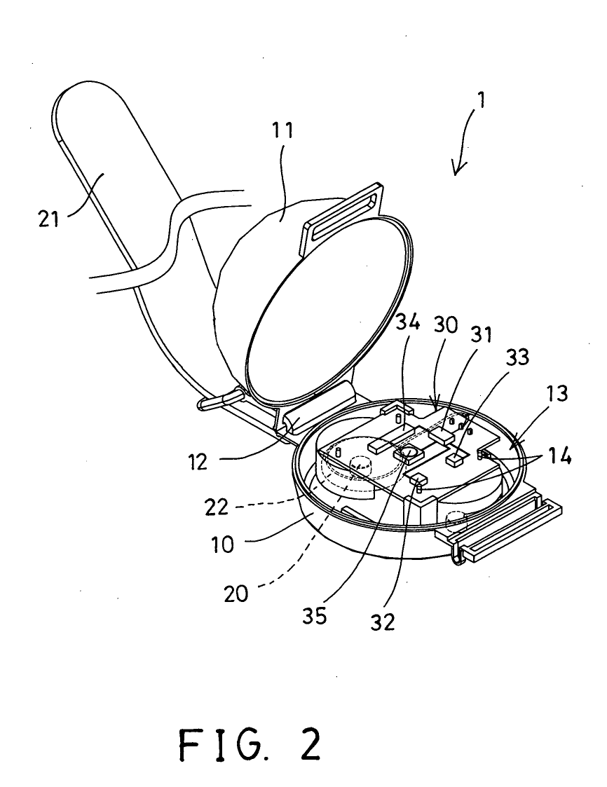

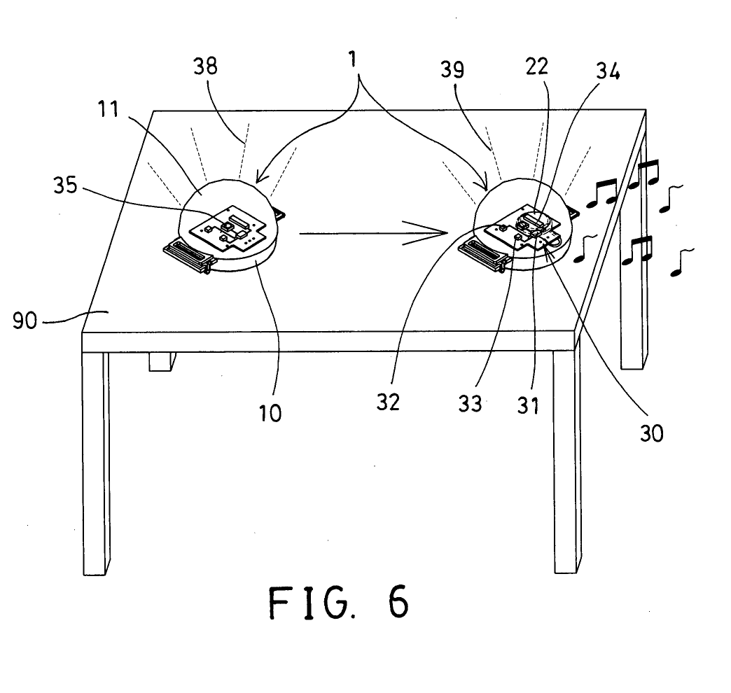

Referring to the drawings, and initially to FIGS. 1-2, a movement responding device 1 in accordance with the present invention comprises a housing 10 including a cover 11 pivotally or rotatably attached or mounted or secured or coupled to the housing 10 with a joint or pivot axle 12, and including a chamber 13 formed therein, such as formed in the housing 10 and/or the cover 11, and including one or more retaining members 14, such as pegs 14 extended or provided in the chamber 13 of the housing 10. One or more attachment elements 20, such as magnets or magnetic elements 20 are attached or mounted or secured to the housing 10 for attaching or mounting or securing the housing 10 onto various supporting objects 90, such as the table 90 (FIG. 6), the shelves (not shown) or the like.

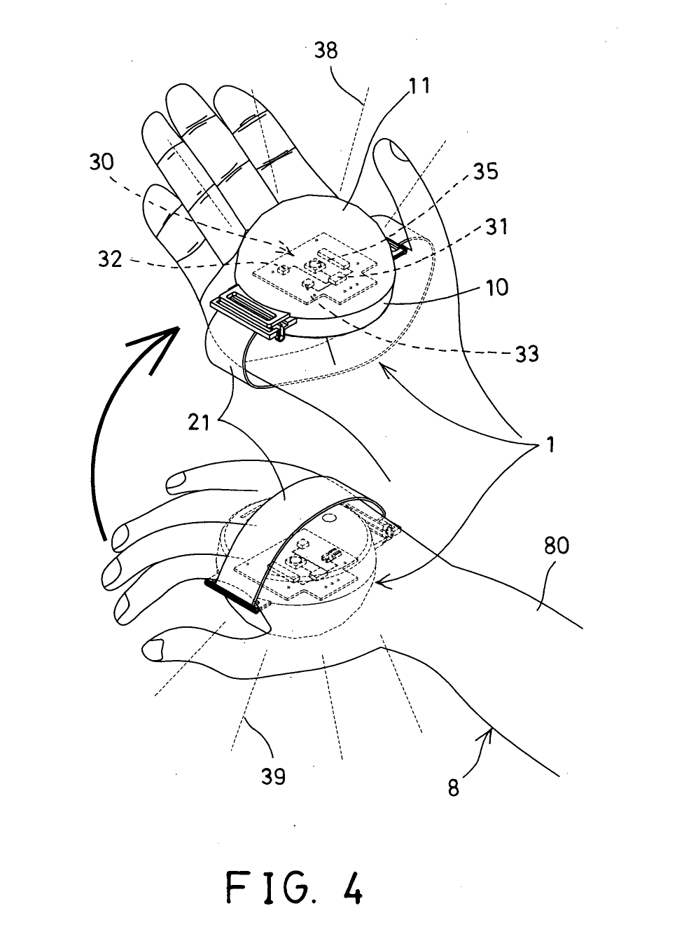

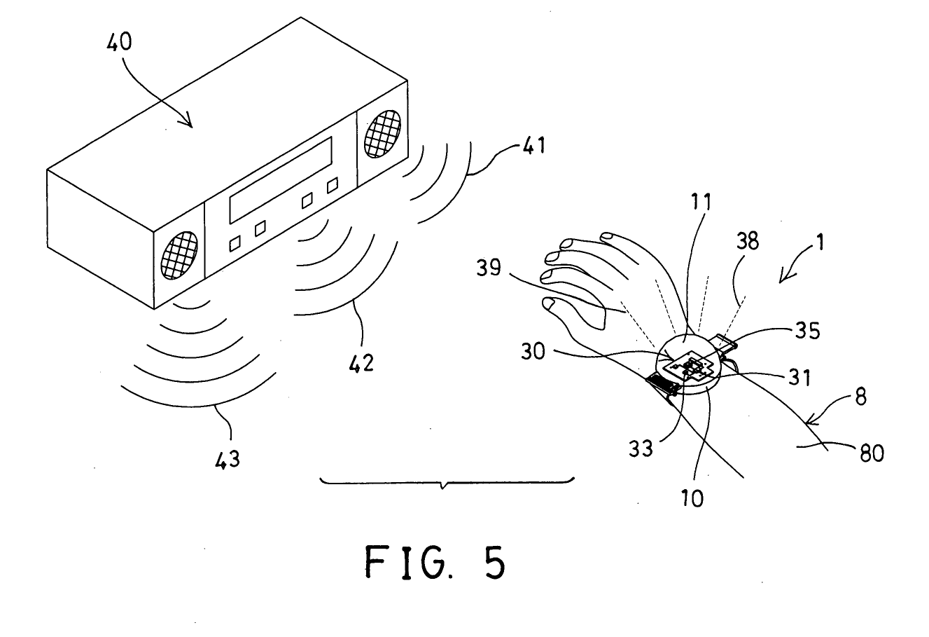

A mounting or connecting or coupling device 21, such as the coupling strap 21 may further be provided and attached or mounted or secured to the housing 10 for attaching or mounting or securing the housing 10 onto the other supporting objects 8, such as the hand 80 of a user 8 (FIGS. 4, 5). The movement responding device 1 further includes a signal or voice or sound generating device 22, such as a buzzer, a player, a speaker or other sound generating devices 22 for generating a sound or voice signal or for playing a music or the like, and particularly provided for generating a sound signal when sensed or detected a movement of an object or the user 8 or in automatic response to the detection of ambient movement or sound.

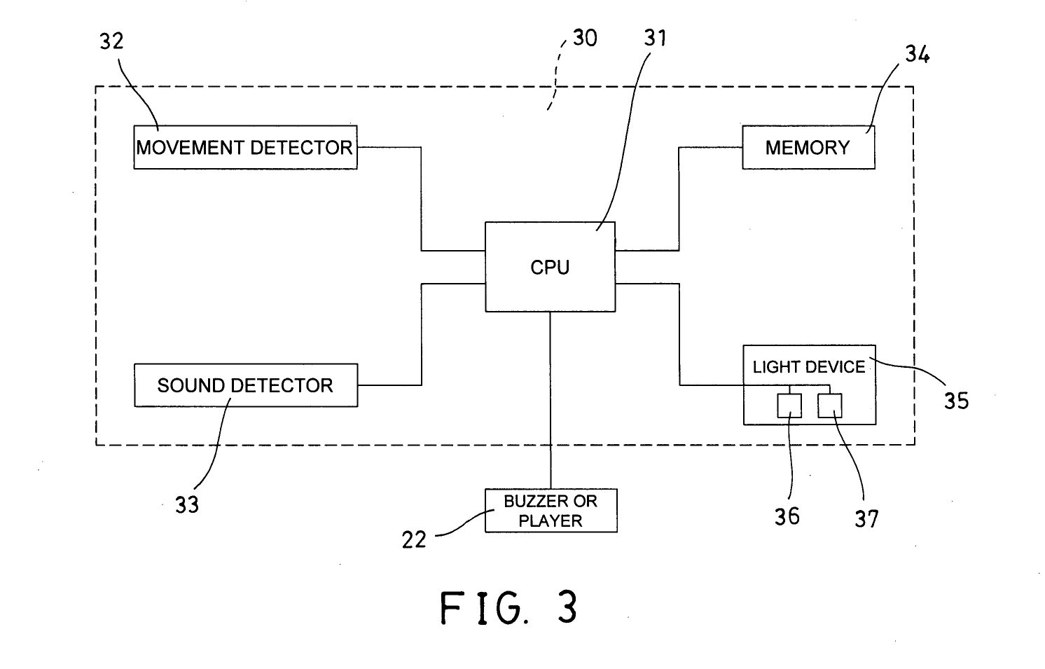

A circuit board 30 is disposed in the chamber 13 of the housing 10 and attached or mounted or secured to the housing 10 with the pegs or retaining members 14, and includes a controller or central processing unit (CPU) or processor or control device 31 attached or mounted or secured to the circuit board 30 and electrically connected or coupled to the sound generating devices 22, a movement detector 32, such as a gyro, a tilting angle detector, a G-sensor, or the like, also attached or mounted or secured to the circuit board 30 and electrically connected or coupled to the control device 31 (FIG. 3) for sensing or detecting a movement of an object or the user 8 and for supplying the sensed or detected data or information or signal to the control device 31, and a sound detector 33 also attached or mounted or secured to the circuit board 30 and electrically connected or coupled to the control device 31 for sensing or detecting a sound of an object or the user 8 and for supplying the sensed or detected data or information or signal to the control device 31.

The circuit board 30 may include one or more memories 34 also attached or mounted or secured to the circuit board 30 and electrically connected or coupled to the control device 31 for storing or memorizing various sounds or music therein and for displaying the sounds or music through the control device 31 and/or the sound generating devices 22, when required, and may include a light device 35 attached or mounted or secured to the circuit board 30 and electrically connected or coupled to the control device 31 and having one or more light elements 36, 37, such as light emitting diodes 36, 37 (FIG. 3) for generating various kinds of light rays 38, 39, such as the red light, the green light, the blue light, the yellow light or the like.

In operation, as shown in FIG. 4, when the housing 10 of the movement responding device 1 is attached or mounted or secured to the hand 80 of the user 8, and when the hand 80 of the user 8 is moved to different status or posture, the movement detector 32 may sense or detect the movement of the hand 80 of the user 8 and may actuate the control device 31 and the light device 35 to generate various kinds of light rays 38, 39 in order to indicate the movement of the hand 80 of the user 8, the control device 31 may also be used to actuate the sound generating devices 22 to display the sounds or music, when required.

As shown in FIG. 5, when the housing 10 of the movement responding device 1 is disposed or moved closer to a sound generator 40, such as a radio, a television, or other music playing facilities 40, the sound detector 33 may sense or detect the sound or music generated by the sound generator 40, for example, the sound detector 33 may sense or detect the low voice or the base sound 41, the medium voice or the tenor sound 42, or the higher voice 43 or the like, and may actuate the control device 31 and the light device 35 to generate various kinds of light rays 38, 39 in response to the detection of the different sounds 41, 42, 43, and/or may actuate the control device 31 and the sound generating devices 22 to generate or display the sounds or music.

As shown in FIG. 6, when the housing 10 of the movement responding device 1 is disposed or attached or mounted or secured to the supporting objects 90, such as the table 90, and when the housing 10 of the movement responding device 1 is moved relative to the supporting objects or table 90, the movement detector 32 may also be used to sense or detect the movement of the housing 10 and may actuate the control device 31 and the sound generating devices 22 to generate or display the sounds or music, and/or may actuate the control device 31 and the light device 35 to generate various kinds of light rays 38, 39 in response to the detection of the movement of the housing 10.

Accordingly, the movement responding device in accordance with the present invention includes a signal generating device for generating a sound or light signal or for reproducing a comforting voice when sensed or detected a movement of an object or a user or in automatic response to the detection of ambient movement or sound.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A movement responding device comprising:
a housing including a chamber formed therein, and
a circuit board disposed in said chamber of said housing and including a control device attached to said circuit board, and including a light device attached to said circuit board and electrically connected to said control device for generating a light, and including a movement detector attached to said circuit board and electrically connected to said control device for detecting a movement of an object and for supplying a detected information to said control device and for actuating said light device to generate the light.

2. The movement responding device as claimed in claim 1, wherein said housing includes a cover pivotally attached to said housing with a pivot axle.

3. The movement responding device as claimed in claim 1, wherein said housing includes at least one attachment element for attaching said housing to a supporting object.

4. The movement responding device as claimed in claim 1, wherein said housing includes a coupling device for attaching said housing to a supporting object.

5. The movement responding device as claimed in claim 1, wherein said circuit board includes at least one memory attached to said circuit board and electrically connected to said control device for storing a sound.

6. The movement responding device as claimed in claim 1, wherein said circuit board includes a sound detector attached to said circuit board and electrically connected to said control device for detecting an ambient sound.

7. The movement responding device as claimed in claim 1, wherein a sound generating device is electrically connected to said control device for generating a sound.
